(19) United States
(12) Patent Application Publication
(10) Pub. No.: US 2014/0310221 A1
(43) Pub. Date: Oct. 16, 2014

(54) INTERPRETABLE SPARSE HIGH-ORDER BOLTZMANN MACHINES

(71) Applicant: NEC Laboratories America, Inc., Princeton, NJ (US)

(72) Inventor: Renqiang Min, Plainsboro, NJ (US)

(73) Assignee: NEC Laboratories America, Inc., Princeton, NJ (US)

(21) Appl. No.: 14/243,918

(22) Filed: Apr. 3, 2014

Related U.S. Application Data
(60) Provisional application No. 61/811,443, filed on Apr. 12, 2013.

(51) Int. Cl. G06N 3/08

(52) U.S. Cl. CPC G06N 3/08
USPC 706/25

(57) ABSTRACT

A method for performing structured learning for high-dimensional discrete graphical models includes estimating a high-order interaction neighborhood structure of each visible unit or a Markov blanket of each unit; once a high-order interaction neighborhood structure of each visible unit is identified, adding corresponding energy functions with respect to the high-order interaction of that unit into an energy function of High-order BM (HBM); and applying Maximum-Likelihood Estimation updates to learn the weights associated with the identified high-order energy functions. The system can effectively identify meaningful high-order interactions between input features for system output prediction, especially for early cancer diagnosis, biomarker discovery, sentiment analysis, automatic essay grading, Natural Language Processing, text summarization, document visualization, and many other data exploration problems in Big Data.

The present application claims priority to Provisional Application Serial 61/811,443 filed 4122013, the content of which is incorporated by reference.

### BACKGROUND

Identifying high-order feature interactions is an important problem in machine learning and effective solutions to this problem have a large set of use scenarios. Particularly, in biomedical applications, interactions among multiple proteins play critical roles in many biological processes, and thus the identification of such high-order interactions itself becomes critical. Theoretically, fully-observable high-order Boltzmann Machines (HBM) are capable of identifying explicit high-order feature interactions. However, they have never been applied to any real problems because they have too many energy terms even for a fair number of features and the learning procedure is prohibitively slow.

### SUMMARY

In one aspect, a method for performing structured learning for high-dimensional discrete graphical models includes estimating a high-order interaction neighborhood structure of each visible unit or a Markov blanket of each unit; once a high-order interaction neighborhood structure of each visible unit is identified, adding corresponding energy functions with respect to the high-order interaction of that unit into an energy function of High-order BM (HBM); and applying Maximum-Likelihood Estimation updates to learn the weights associated with the identified high-order energy functions.

In another aspect, an interpretable Sparse High-order Boltzmann Machine (SHBM) can be used with an efficient learning algorithm to learn an SHBM for Big-Data problems. The energy function of an HBM as in to have a combination of different orders of feature interactions up to a maximum order allowed. Sparsity constraints can be used on the feature interaction terms so as to construct a sparse model. The learning algorithm for SHBM can be decoupled into two steps: high-order interaction neighborhood estimation and interaction weight learning. An efficient sparse high-order logistic regression method, denoted as shooter, can be used for identifying interpretable high-order feature interactions and thus to determine the energy function of an SHBM. The shooter method greedily explores the structures among feature interactions via solving a set of l₁-regularized logistic regression problems. Significant speed-up is enabled by organizing the search space within a tree structure as well as a block-wise expansion of the possible interactions conforming to the tree. Given the energy function determined by shooter, different sampling algorithms can be used that scale to large number of features and interactions in order to finally learn the interaction weights within an SHBM.

Advantages of the system may include one or more of the following. Tests on both large synthetic and real datasets demonstrate that SHBM and its sub-routine shooter can effectively identify problem-inherent high-order feature interactions in large-scale settings, which has great potential to be applied to many Big-Data problems. The system can effectively identify meaningful high-order interactions between input features for system output prediction, especially for early cancer diagnosis, biomarker discovery, sentiment analysis, automatic essay grading, and other Natural Language Processing problems. The system is scalable to huge-dimensional datasets that are common in biomedical applications, information retrieval and Natural Language Processing. The system can be used for text summarization, document visualization, and many other data exploration problems in Big Data. The system can be used for graphical text summarization, where documents are represented with a graph, in which nodes correspond to discriminative words or phrases identified by the system, and interactions between nodes correspond to essential word or phrase interactions identified by the system.

### BRIEF DESCRIPTION OF THE DRAWINGS

FIG. 1 shows an exemplary process for identifying Interpretable High-Order Feature Interactions and for System Output Prediction.

FIG. 2 shows an exemplary computer for identifying Interpretable High-Order Feature Interactions and for System Output Prediction.

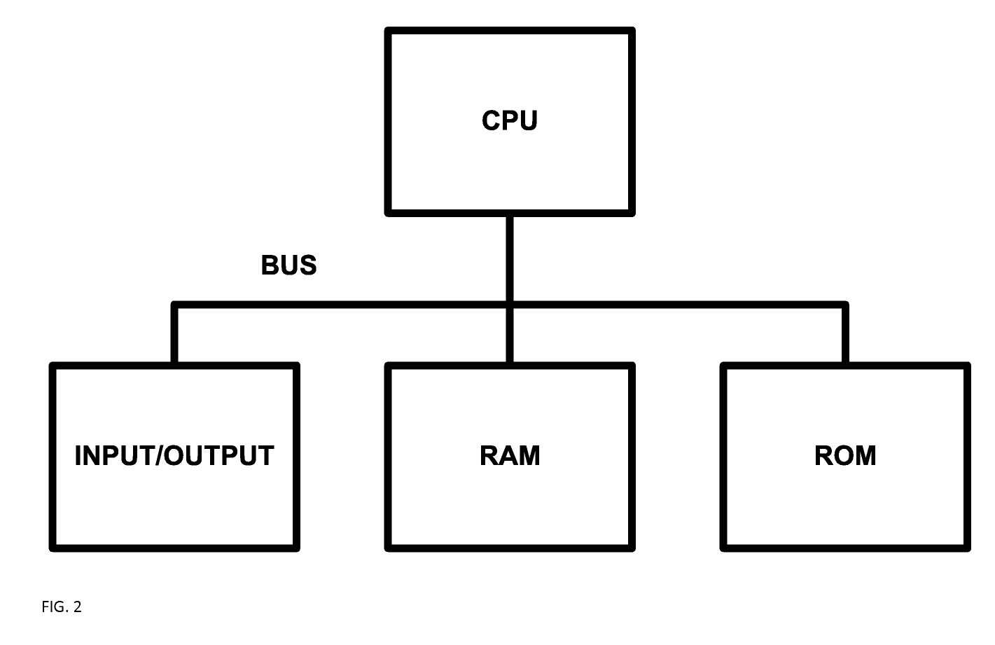

### DESCRIPTION

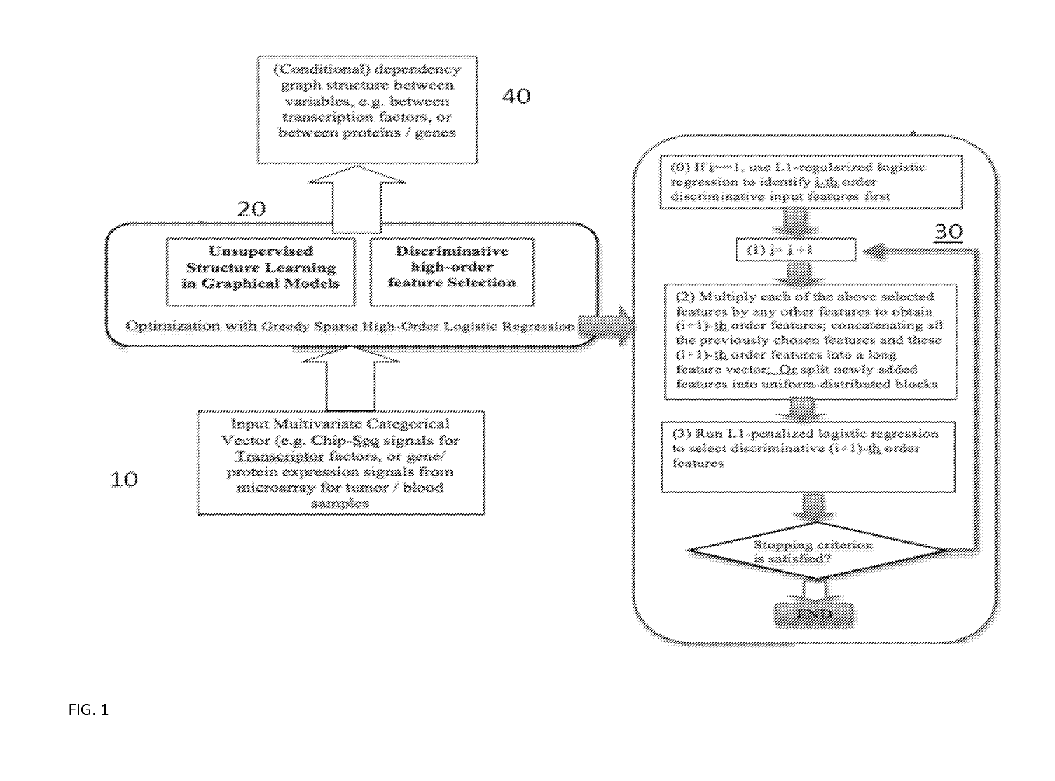

FIG. 1 shows an efficient approach for learning a fully-observable high-order Boltzmann Machine based on sparse learning and contrastive divergence, resulting in an interpretable Sparse High-order Boltzmann Machine, denoted as SHBM. Experimental results on synthetic datasets and a real dataset demonstrate that SHBM can produce higher pseudo-log-likelihood and better reconstructions on test data than the state-of-the-art methods. In addition, we apply SHBM to a challenging bioinformatics problem of discovering complex Transcription Factor interactions. Compared to conventional Boltzmann Machine and directed Bayesian Network, SHBM can identify much more biologically meaningful interactions that are supported by recent biological studies. SHBM is the first working Boltzmann Machine with explicit high-order feature interactions applied to real-world problems.

Turning now to FIG. 1, the system first receives multivariate categorical vectors such as chip-sequential signals for transcription factors or geneprotein expression signals from a microarray for tumor or blood samples (10). Next, the process performs unsupervised structure learning in graphical models as well as a discriminative high-order feature selection (20). In 20, the process also optimizes the model with a Greedy Sparse High-Order Logistic Regression (30). In 30, the process checks if i equals 1, then L1-regularized logistic regression is used to identify an i-th order discriminative input feature (0), and i is auto-incremented (1). Next, in 2, the process 30 multiplies each discriminative feature by all the other features to obtain i+1 order features. The process then concatenates all previously chosen features and the i+1 order features into a long feature vector. The process 30 may also split newly added features into uniformly distributed blocks (2). Next, the process 30 runs L1-penalized logistic regression to select a discriminative i+1 order features. The process then checks if a stopping criterion has been satisfied and if not, loops back to step 1 and otherwise exits.

In one embodiment called Sparse High-Order IOgisTicrEgRession (SHOOTER) for both supervised discriminative high-order feature interaction identification (feature selection) and unsupervised feature interaction identification (structure learning in Graphical Models). We will describe SHOOTER for feature selection first. Given a dataset containing data samples with input feature vector x and discrete output target variable y (we will use binary target variable as a running example and the extension to a discrete case is simple), we want to identify single input features and high-order polynomial terms that are products of single feature values predictive of target variable. The search space containing an possible combinations of single features and high-order polynomial features is exponential in the number of input features, so we cannot solve this problem in a brute force way. In SHOOTER, we adopt a greedy approach I:tased on L1-regularized logistic regression. We use L1-regularized logistic regression to identify first-order discriminative input features first: then we multiply each of these first-order features by any other feature to obtain second-order features: concatenating all the first-order features and second-order features into a long feature vector, we run L1-penalized logistic regression again to select discriminative second-order features without penalizing first-order features; and we repeat this process until we reach the specified maximum order of feature interactions or we cannot improve the average conditional log-likelihood of the target variable given input features. We use a tree data structure to help our greedy feature selection, and we use Projected Scaled Sub-Gradient method to efficiently solve L1-regularized logistic regression

For unsupervised structure learning in Graphical Models, specifically for learning the structure of Sparse High-Order Boltzmann Machine, we transform the joint log-likelihood maximization problem into a pseudo log-likelihood maximization problem, and we use SHOOTER to identify the high-order neighborhood of each variable separately, and then we use contrastive divergence based on damped mean-field updates or prolonged Gibb sampling to learn the parameters associated with first-order and high-order energy terms.

Extension of SHOOTER to model discrete target variable is simple: instead of using L1-penalized logistic regression, we use L1-penalized multinomial logistic regression.

Before we detail our implementation of the invention, a review of traditional fully observable Boltzmann Machines (BMs) and High-order BM (HBMs) is discussed next. A fully-observable BM is an undirected graphical model with symmetric connections between p visible units vε{0,1}. The joint probability distribution of a configuration v is defined as follows:

$$p ( v ) = \frac{1}{Z} exp ( - E ( v ) ) , \qquad ( 1 )$$

where Z=Σᵤexp(−E(u)) is the partition function. The energy E(v) is defined as

$$- E ( v ) = {\sum }_{ij}^{ } {W}_{ij} {v}_{i} {v}_{j} + {\sum }_{i}^{ } {b}_{i} {v}_{i} , \qquad ( 2 )$$

where bᵢ is the bias on unit vᵢ, and Wᵢⱼ is the connection weight between unit vᵢ and vⱼ. The weights are updated via maximizing the log-likelihood of the observed input data using the following gradient descent

ΔWᵢⱼ=ε( [symbol] vⱼvⱼ [symbol] − [symbol] vᵢvⱼ [symbol] _{∞}),

where is the learning rate, [symbol] • [symbol] _{data} is the expectation with respect to the data distribution and [symbol] • [symbol] _{∞} is the expectation with respect to the model distribution.

BMs are conventionally used to model pairwise interactions between input features. They have been extended in to model high-order interactions by incorporating higher-order energy functions. For example, the quadratic energy function as in eqn:bme can be replaced by a sum of energy functions with orders from 1 to m as follows:

$$- E ( v ) = {\sum }_{j = 1}^{m} {\sum }_{{i}_{1} {i}_{2 } … {i}_{j}}^{ } {W}_{{i}_{1} {i}_{2 } … {i}_{j}} {v}_{{i}_{1}} {v}_{{i}_{2 }} … {v}_{{i}_{j}} ,$$

where Wᵢ_{₁}ᵢ_{₂}_{. . . i}_{ⱼ} is the weight for the order-j interaction among units vᵢ_{₁}, vᵢ_{₂}, . . . , and vᵢ_{ⱼ}. The derived model is the so-called High-order Boltzmann Machine (HBM), and its learning rule with respect to order-j interactions correspondingly becomes

ΔWᵢ_{₁}ᵢ_{₂}_{. . . i}_{ⱼ}=ε( [symbol] vᵢ_{₁}vᵢ_{₂} . . . vᵢ_{ⱼ} [symbol] _{data}− [symbol] vᵢ_{₁}vᵢ_{₂} . . . vᵢ_{ⱼ} [symbol] _{∞}). (3)

However, due to the painfully slow Gibbs Sampling procedure to get samples from the model distribution, HBMs have never been applied to any interesting practical problems.

Next, details in one of our methods for solving HBMs with sparsity constraint are discussed. In practice, it is typically infeasible for HBMs to include all possible energy functions of different orders. Thus, we need to perform structure learning, which is a challenging task for high-dimensional discrete graphical models. Following, the structure learning of HBMs could be conducted by minimizing the following l₁-regularized negative log-likelihood

$${min}_{w} E ( v ) + log Z + λ {\vert W \vert}_{1} .$$

That is, we constrain the HBM to have only a sparse set of all possible high-order interactions. However, calculating the above negative log-likelihood and its gradient is intractable. To address this, we convert the problem of minimizing the negative log-likelihood of observed data into that of minimizing the negative pseudo log-likelihood as proposed in. Specifically, we solve the following optimization function

$${min}_{W} {\sum }_{i}^{ } log p ( {v}_{i} \vert {v}_{- i} , W ) + λ {\vert W \vert}_{1} ,$$

where v₋ᵢ is the set of visible units except vᵢ. Essentially, the above optimization takes the form of a set of l₁-regularized logistic regression problems that are not independent due to the shared parameters W.

Due to the extremely large space of the parameters for the high-order interactions, we approximate the above pseudo log-likelihood further by utilizing a strategy proposed by Wainwright and propose the following decoupled 2-step method for learning a Sparse High-order Boltzmann Machine, denoted as SHBM.

Step 1: high-order interaction neighborhood estimation:

we first estimate the high-order interaction neighborhood structure of each visible unit, i.e., the Markov blanket of each unit. We formulate this problem as a high-order feature selection problem and propose a learning algorithm, denoted as shooter, as described in Section 3.2. In particular, for each visible unit (i.e., each feature), we consider a regression problem from all the other visible units and their high-order interactions.

Step 2: SHBM weight learning:

Once the high-order interaction neighborhood structure of each visible unit is identified, we add the corresponding energy functions with respect to the high-order interaction of that unit into the energy function of HBM. Then we use Maximum-Likelihood Estimation updates as in Equation 3 to learn the weights associated with the identified high-order energy functions, which requires drawing samples from the model distribution. In Section 4, we present Gibbs Sampling and Mean-Field updates for obtaining samples. Instead of drawing samples exactly from the equilibrium model distribution, we only perform sampling a few steps and use Contrastive Divergence (CD) to update the weights.

Sparse High-Order Logistic Regression for SHBM is detailed next. First, we provide a brief overview of l₁-regularized Logistic Regression. Given a dataset of n data points {xᵢ, yᵢ}, where xᵢεR^{p}, yᵢε{+1,−1}, and i=1, . . . , n, l₁-regularized Logistic Regression, denoted as l₁-LR, seeks a classification function ƒ(w,b) by solving the following tᵢ-regularized optimization problem:

$${min}_{w , b} f ( w , b ) = {min}_{w , b} L ( w , b ) + λ {\vert w \vert}_{1} , \\ where$$

$$L ( w , b ) = {\sum }_{i = 1}^{n} log ( 1 + exp ( - {y}_{i} ( {w}^{T} {x}_{i} + b ) ) ) ,$$

and PwP₁ is the l₁-norm of w. The sub-differential of ƒ(w,b) with respect to wⱼ is

∂ⱼf(w,b)=∇ⱼL(w,b)+λsign(wⱼ), (4)

where ∇ⱼL(w,b) is the standard gradient of the loss function L(w,b) with respect to wⱼ. Since the pseudo-gradient of ƒ(w,b) is the sub-differential of ƒ(w,b) at w with minimum norm, and because the sub-differential in subdiff is separable in the variables wⱼ's, the pseudo-gradient of ƒ(w,b) with respect to each variable wⱼ can be calculated in a closed form.

Among many algorithms solving the above optimization problem (see for a comprehensive review), Projected Scaled Sub-Gradient (PSSG) method is one of the most efficient. In specific, in PSSG, during each iteration, the weight vector w is split into two sets: a working set that contains all sufficiently non-zero weights and an active set that is the complement of the working set. Then an L-BFGS update is performed on the working set and a diagonally-scaled pseudo-gradient update is performed on the active set so as to get the descent direction d. Finally, orthant projections are applied on both sets. The orthant projection P on weight vector w with the descent direction d takes the following form:

$${P ( w + d )}_{j} = \{ \begin{matrix}0 & {ifw}_{j} ( {w}_{j} + {d}_{j} ) < 0 , \\ {w}_{j} + {d}_{j} & otherwise ,\end{matrix} \qquad ( 5 )$$

which ensures that some weights are set to exactly 0 and the weight updates never cross points of non-differentiability.

For Sparse High-Order l₁-Regularized Logistic Regression, we extend the conventional l₁-LR to have both single features and multiplicative feature interactions of orders up to m as predictors with l₁ regularization, and this method is denoted as sparse high-order logistic regression (shooter). The optimization problem of shooter with feature interactions of maximum order m is as follows:

$${min}_{w , b} {\sum }_{i = 1}^{n} log \{ 1 + exp [ - {y}_{i} ( {\sum }_{k = 1}^{m} {\sum }_{{j}_{1} < {j}_{2} < … < {j}_{k}}^{ } {w}_{{j}_{1} {j}_{2 } … {j}_{k}} {x}_{i}^{{j}_{1}} {x}_{i}^{{j}_{2}} … {x}_{i}^{{j}_{k}} + b ) ] \} + {\sum }_{k = 1}^{m} {λ}_{k} {\sum }_{{j}_{1} < {j}_{2} < … < {j}_{k}}^{ } \vert {w}_{{j}_{1} {j}_{2} {…j}_{k}} \vert , \qquad ( 6 )$$

where xₗ^{j} denotes the j-th feature of xᵢ. Solving the problem in eqn:shooter directly is intractable even for fair feature set size p and small interaction order m (e.g. p=500, m=6). Thus, we propose a greedy block-wise optimization method to solve eqn:shooter.

We decompose the above problem into several sub-problems and solve the sub-problems greedily from the lowest order 1 up to the maximum order m as follows.

Step 1:

First, we denote the set of all the single features as F₀⁽¹⁾, that is,

F₀⁽¹⁾={x^{j}|∀j}

We use PSSG to solve the optimization problem as in Equation 7.

$${min}_{{w}^{( 1 )} , {b}^{( 1 )}} {\sum }_{i = 1}^{n} log \{ 1 + exp [ - {y}_{i} ( {\sum }_{{x}_{i}^{j} ∈ {F}_{0}^{( 1 )}}^{ } {w}_{j}^{( 1 )} {x}_{i}^{j} + {b}^{( 1 )} ) ] \} + {λ}_{1} {\sum }_{{x}_{i}^{j} ∈ {F}_{0}^{( 1 )}}^{ } \vert {w}_{j}^{( 1 )} \vert . \qquad ( 7 )$$

The discriminative single features are identified as the ones which have non-zero weights wⱼ⁽¹⁾ across all the data points. We denote this set of identified single features by F⁽¹⁾, that is,

F⁽¹⁾={x^{j}|x^{j}εF₀⁽¹⁾,wⱼ⁽¹⁾≠0}, where j=1, . . . ,p₁,p₁=|F⁽¹⁾|.

Step 2:

We multiply each discriminative feature in F⁽¹⁾ with all the rest p−1 single features in F₀⁽¹⁾ to construct the set of all possible second-order feature interactions F₀⁽²⁾, that is

F₀⁽²⁾={x^{j}^{₁}x^{j}^{₂}|x^{j}^{₁}εF⁽¹⁾,x^{j}^{₂}εF₀⁽¹⁾,j₁≠j₂}

We solve the optimization problem as in Equation 8

$${min}_{{w}^{( 2 )} , {b}^{( 2 )}} {\sum }_{i = 1}^{n} log \{ 1 + exp [ - {y}_{i} ( {\sum }_{{x}_{i}^{{j}_{1}} ∈ {F}^{( 1 )}}^{ } {w}_{{j}_{1}}^{( 2 )} {x}_{i}^{{j}_{1}} + {\sum }_{{x}_{i}^{{j}_{1}} {x}_{i}^{{j}_{2}} ∈ {F}_{0}^{( 2 )}}^{ } {w}_{{j}_{1} {j}_{2}}^{( 2 )} {x}_{i}^{{j}_{1}} {x}_{i}^{{j}_{2}} + {b}^{( 2 )} ) ] \} + {λ}_{1} {\sum }_{{x}_{i}^{{j}_{1}} ∈ {F}^{( 1 )}}^{ } \vert {w}_{{j}_{1}}^{( 2 )} \vert + {λ}_{2} {\sum }_{{x}_{i}^{{j}_{1}} {x}_{i}^{{j}_{2}} ∈ {F}_{0}^{( 2 )}}^{ } \vert {w}_{{j}_{1} {j}_{2}}^{( 2 )} \vert . \qquad ( 8 )$$

so as to identify discriminative second-order feature interaction set F⁽²⁾, that is,

F⁽²⁾={x^{j}^{₁}x^{j}^{₂}|x^{j}^{₁}x^{j}^{₂}εF₀⁽²⁾,wⱼ_{₁}ⱼ_{₂}⁽²⁾≠0}.

Step 3:

We multiply each discriminative (k−1)-th order feature interaction in set F^{(k-1)} with p−k+1 other single features in F₀⁽¹⁾ to construct the set of all possible k-th order interactions F₀^{(k)}, that is,

F₀^{(k)}={x^{j}^{₁}x^{j}^{₂} . . . x^{j}^{ₖ}|x^{j}^{₁}x^{j}^{₂} . . . x^{j}^{_{k−1}}εF^{(k-1)},x^{j}^{ₖ}εF₀⁽¹⁾,jₖ≠j_{k-q},∀q=1, . . . k−1}

Then from F₀^{(k)} we identify discriminative feature interaction set F^{(k)} by solving the optimization problem as in Equation 9.

$${min}_{{w}^{( k )} , {b}^{( k )}} {\sum }_{i = 1}^{n} log \{ 1 + exp [ - {y}_{i} ( \begin{matrix}{\sum }_{q = 1}^{k - 1} {\sum }_{{x}_{i}^{{j}_{1}} {x}_{i}^{{j}_{2}} … {x}_{i}^{{j}_{q}} ∈ {F}^{( q )}}^{ } {w}_{{j}_{1} {j}_{2 } … {j}_{q}}^{( k )} {x}_{i}^{{j}_{1}} {x}_{i}^{{j}_{2}} … {x}_{i}^{{j}_{q}} + \\ {\sum }_{{x}_{i}^{{j}_{1}} {x}_{i}^{{j}_{2}} {…x}_{i}^{{j}_{k}} ∈ {F}_{0}^{( k )}}^{ } {w}_{{j}_{1} {j}_{2 } … {j}_{q}}^{( k )} {x}_{i}^{{j}_{1}} {x}_{i}^{{j}_{2}} … {x}_{i}^{{j}_{q}} + {b}^{( k )}\end{matrix} ) ] \} + {\sum }_{q = 1}^{k - 1} {λ}_{q} {\sum }_{{x}_{i}^{{j}_{1}} {x}_{i}^{{j}_{2}} … {x}_{i}^{{j}_{q}} ∈ {F}^{( q )}}^{ } \vert {w}_{{j}_{1} {j}_{2}}^{( k )} … {j}_{q} \vert + {λ}_{k} {\sum }_{{x}_{i}^{{j}_{1}} {x}_{i}^{{j}_{2}} … {x}_{i}^{{j}_{k}} ∈ {F}_{0}^{( k )}}^{ } \vert {w}_{{j}_{1} {j}_{2} }^{( k )} … {j}_{k} \vert . \qquad ( 9 )$$

and the order-k discriminative feature interaction set F^{(k)} is identified as

F^{(k)}={x^{j}^{₁}x^{j}^{₂} . . . x^{j}^{ₖ}|x^{j}^{₁}x^{j}^{₂} . . . x^{j}^{ₖ}εF₀^{(k)},wⱼ_{₁}ⱼ_{₂}_{. . . j}_{ₖ}^{(k)}≠0}

Note that in Equation 9 we include discriminative single features and discriminative lower-order interactions F⁽¹⁾, . . . , F^{(k-1)} into the l₁-regularized optimization problem for order k so as to optimally remove less important lower-order interactions when high-order interactions present. To speed up the optimization, we divide each identified discriminative feature interaction set F into equal-sized blocks, and we expand each block and solve the l₁-regularized optimization problem for the particular block.

The above greedy optimization approach sequentially identifies discriminative feature interactions of different orders that essentially form a tree structure, because each k-th order discriminative feature interactions must have at least one of its (k−1)-th order constituents belonging to F^{(k-1)}, where k>1. Although this greedy approach can only identify a sub-optimal solution to the original intractable optimization problem in eqn:shooter, it performs very well in practice as demonstrated by our experimental results.

Sampling Methods for SHBM are detailed next. In this section, we present Contrastive Divergence (CD) learning based on Gibbs Sampling (GS) and damped Mean-Field updates (MF). The weight updates in SHBM based on CD are as follows,

ΔWᵢ_{₁}ᵢ_{₂}_{. . . i}_{ⱼ}=ε( [symbol] vᵢ_{₁}vᵢ_{₂} . . . vᵢ_{ⱼ} [symbol] _{data}− [symbol] vᵢ_{₁}vᵢ_{₂} . . . vᵢ_{ⱼ} [symbol] _{T}), (10)

where [symbol] vᵢ_{₁}vᵢ_{₂} . . . vᵢ_{ⱼ} [symbol] is calculated using the samples obtained from different sampling methods after T steps. Although CD updates do not exactly follow the gradient of data log-likelihood, it works well in practice.

Gibbs sampling (GS) can be used within CD for drawing samples. To perform Gibbs Sampling, we initialize r⁽⁰⁾ to be a random data vector, and we sample each visible unit vⱼ sequentially using the conditional probability

p^{(t)}(vⱼ|r₁^{(t)}, . . . ,rⱼ₋₁^{(t)},rⱼ₊₁^{(t-1)}, . . . ,rₚ^{(t-1)}

to get the sample for unit vⱼ in step t, where j=1, . . . , p, t=1, . . . , T, and p is the total number of visible units. Then we use the statistics in the T-step samples to calculate the second term in Equation 10 for weight updates.

However, standard GS cannot be performed in parallel due to the sequential sampling procedure over all the visible units. To speed up learning, we use mean-field approximations (MF) to calculate the sampled values for all the visible units in each step in parallel given the sample values in the previous step (please note that GS and MF have the same computational complexity without parallelization). In specific, we use the damped version of mean-field updates to draw samples to increase sampling stability. Starting from a random data vector r⁽⁰⁾, we calculate the t-step sample for each visible unit vⱼ as follows,

rⱼ⁽¹⁾=λrⱼ^{(t-1)}+(1−λ)p(vⱼ=1|v₋ⱼ,W),

where t=1, . . . , T, and p(vᵢ=1|v₋ⱼ,W) is the conditional probability of vᵢ=1 given its neighborhood interactions. Please note that, unlike in GS, we can calculate r^{(t)} for all the visible units in parallel to speed up our computation because the calculation for r^{(t)} is only dependent on r^{(t-1)}. In all our experiments, we set λ=0.2 for parameter learning based on Damped MF updates.

As discussed above, SHBM is an interpretable sparse high-order Boltzmann machine, with a two-step learning process. In the first step of learning, a greedy sparse learning approach via L-regularized logistic regression to identify high-order feature interactions so as to identify interaction neighborhood structure for the SHBM. In the second step of SHBM, different sampling methods are used to learn the interaction weights in SHBM. Experimental results demonstrate that the SHBM outperforms other methods in identifying interaction neighborhood by exploring high-order interactions during classification. In addition, weight learning in SHBM produces better rankings among interactions and better generative models than other competing models. In particular, SHBM successfully identifies biologically meaningful and significant interactions from a real biological dataset, whereas other state-of-the-art methods miss such interactions. SHBM is also demonstrated to be scalable to very large problems, while the state-of-the-art method for high-order interactions fail.

We can incorporate abundant group information of features to enhance the power of shooter, when limited data points are available. Moreover, we can add hidden units and gated hidden units to increase the generative power of SHBM for unsupervised feature interaction identification and for collaborative filtering applications.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for performing structured learning for high-dimensional discrete graphical models, comprising:
estimating a high-order interaction neighborhood structure of each visible unit or a Markov blanket of each unit;
once a high-order interaction neighborhood structure of each visible unit is identified, adding corresponding energy functions with respect to the high-order interaction of that unit into an energy function of High-order BM (HBM); and
applying Maximum-Likelihood Estimation updates to learn the weights associated with the identified high-order energy functions.

2. The method of claim 1, comprising determining an energy function of an HBM to have a combination of different orders of feature interactions up to a maximum order.

3. The method of claim 1, comprising applying sparsity constraints on feature interaction terms to construct a sparse model.

4. The method of claim 1, wherein the learning for the HBM is decoupled into two steps.

5. The method of claim 1, comprising applying high-order interaction neighborhood estimation and interaction weight learning.

6. The method of claim 1, comprising organizing the search space within a tree structure and a block-wise expansion of possible interactions conforming to the tree structure.

7. The method of claim 1, comprising applying a sparsehigh-order logistic regression method (shooter) for identifying interpretable high-order feature interactions and to determine an energy function of an SHBM.

8. The method of claim 7, comprising greedily exploring structures among feature interactions by solving a set of l₁-regularized logistic regression problems.

9. The method of claim 7, comprising applying different sampling algorithms that scale to large number of features and interactions to learn interaction weights within an SHBM for an energy function determined by shooter.

10. The method of claim 1, comprising determining a joint probability distribution of a configuration v as:
$$p ( v ) = \frac{1}{Z} exp ( - E ( v ) ) ,$$
where Z=Σᵤexp(−E(u)) is the partition function and energy E(v) is:
$$- E ( v ) = {\sum }_{ij}^{ } {W}_{ij} {v}_{i} {v}_{j} + {\sum }_{i}^{ } {b}_{i} {v}_{i} ,$$
where bᵢ is a bias on unit vᵢ, and Wᵢⱼ is a connection weight between unit vᵢ and vⱼ.

11. A system for performing structured learning for high-dimensional discrete graphical models, comprising:
a processor to execute computer code;
computer code for estimating a high-order interaction neighborhood structure of each visible unit or a Markov blanket of each unit;
computer code for adding corresponding energy functions with respect to the high-order interaction of that unit into an energy function of High-order BM (HBM) once a high-order interaction neighborhood structure of each visible unit is identified; and
computer code for applying Maximum-Likelihood Estimation updates to learn the weights associated with identified high-order energy functions.

12. The system of claim 11, comprising computer code for determining an energy function of an HBM to have a combination of different orders of feature interactions up to a maximum order.

13. The system of claim 11, comprising computer code for applying sparsity constraints on feature interaction terms to construct a sparse model.

14. The system of claim 11, wherein the computer code for learning for the HBM is decoupled into two steps.

15. The system of claim 11, comprising computer code for applying high-order interaction neighborhood estimation and interaction weight learning.

16. The system of claim 11, comprising computer code for organizing the search space within a tree structure ands a block-wise expansion of possible interactions conforming to the tree structure

17. The system of claim 11, comprising computer code for applying a sparsehigh-order logistic regression method (shooter) for identifying interpretable high-order feature interactions and to determine an energy function of an SHBM.

18. The system of claim 17, comprising computer code for greedily exploring structures among feature interactions by solving a set of l₁-regularized logistic regression problems.

19. The system of claim 11, comprising computer code for applying different sampling algorithms that scale to large number of features and interactions to learn interaction weights within an SHBM for an energy function determined by shooter.

20. The system of claim 11, comprising computer code for determining a joint probability distribution of a configuration v as:
$$p ( v ) = \frac{1}{Z} exp ( - E ( v ) ) ,$$
where Z=Σᵤexp(−E(u)) is the partition function and energy E(v) is:
$$- E ( v ) = {\sum }_{ij}^{ } {W}_{ij} {v}_{i} {v}_{j} + {\sum }_{i}^{ } {b}_{i} {v}_{i} ,$$
where bᵢ is a bias on unit vᵢ, and Wᵢⱼ is a connection weight between unit vᵢ and vⱼ.
